(19) United States
(12) Patent Application Publication
(10) Pub. No.: US 2025/0147238 A1
(43) Pub. Date: May 8, 2025

(54) FIBER SPLICE PROTECTOR CONFIGURED TO PERMIT ROUTING OF A FIBER SPLICE CONNECTION ALONG A CURVED PATH WITHOUT DEGRADING OPTICAL AND MECHANICAL PERFORMANCE OF THE FIBER SPLICE CONNECTION

(71) Applicant: BELDEN CANADA ULC, SAINT-LAURENT (CA)

(72) Inventors: Massimo P. CARBONI, Montréal (CA); Lucas RAKOTO-SAM, Montréal (CA)

(73) Assignee: BELDEN CANADA ULC, SAINT-LAURENT (CA)

(21) Appl. No.: 18/936,678

(22) Filed: Nov. 4, 2024

Related U.S. Application Data
(60) Provisional application No. 63/547,218, filed on Nov. 3, 2023.

(51) Int. Cl. G02B 6/255

(52) U.S. Cl. CPC G02B 6/2558

(57) ABSTRACT

A fiber splice protector may include a splice protection portion having a through bore extending along a length thereof and being structurally configured to receive a splice connection of a first fiber with a second fiber therein and a strength portion configured to extend along at least a portion of the length of the splice protection portion. The strength portion is structurally configured to limit bending of the splice connection to a minimize bend radius so as to permit the strength portion to be routed along a curved path without degrading optical and mechanical performance of the splice connection.

### CROSS-REFERENCE TO RELATED APPLICATION

This application claims the benefit of U.S. Provisional Application No. 63/547,218, filed Nov. 3, 2023, which is currently pending, the disclosure of which is hereby incorporated by reference herein in its entirety.

### TECHNICAL FIELD

The present disclosure is directed to a fiber splice protector and, more particularly, to a fiber splice protector that is configured to permit routing of a fiber splice connection along a curved path.

### BACKGROUND

The use of cable signal pathways to carry signals and data has become relatively commonplace in regions of the world that utilize electronic devices and computers regularly. As cable networks expand and evolve to meet consumer and industry demand for robust signal pathways, cable connections become prevalent. While assorted components and assemblies can conventionally protect a cable connection, such components and assemblies may experience practical challenges and difficulties that add time, complexity, and/or risk to the integrity of a signal pathway, particularly in residential sites where cable routing can incur relatively sharp bends.

For these reasons, it is a continued goal for cabled signal pathways to have robust connections that provide environmental and physical protection while allowing sufficient pliability and flexibility to be installed in a diverse variety of sites.

Therefore, it may be desirable to provide a fiber splice protector that is configured to permit routing of a fiber splice connection along a curved path without degrading optical and mechanical performance of the fiber splice connection.

### SUMMARY

In accordance with various aspects of the disclosure, a fiber splice protector may include an inner protection portion having a through bore extending along a length thereof and being structurally configured to receive a fiber splice portion therein, a strength portion configured to extend along at least a portion of the length of the inner protection portion, and an outer protection portion having a through bore extending along a length thereof and being structurally configured to receive the inner protection portion and the strength portion therein. The fiber splice portion may include a splice connection of a first fiber with a second fiber. The strength portion may be structurally configured to limit bending of the fiber splice portion to a minimize bend radius so as to permit the outer protection portion to be routed along a curved path without degrading optical and mechanical performance of the fiber splice portion.

According to some embodiments of the aforementioned splice protector, the strength portion may include an elongated flexible portion.

According to some embodiments of the aforementioned splice protectors, the strength portion may include a contoured surface portion facing the inner protection portion; and the contoured surface portion is structurally configured to limit bending of the fiber splice portion to the minimum bend radius.

According to some embodiments of the aforementioned splice protectors, the strength portion may include a helical spring that is configured to encircle the inner protection portion and that is structurally configured to limit bending of the fiber splice portion to the minimum bend radius.

In accordance with various aspects of the disclosure, a fiber splice protector may include a splice protection portion having a through bore extending along a length thereof and being structurally configured to receive a splice connection of a first fiber with a second fiber therein, and a strength portion configured to extend along at least a portion of the length of the splice protection portion. The strength portion may be structurally configured to limit bending of the splice connection to a minimize bend radius so as to permit the strength portion to be routed along a curved path without degrading optical and mechanical performance of the splice connection.

According to some embodiments of the aforementioned splice protectors, the strength portion may be structurally configured to receive the splice protection portion therein.

According to some embodiments of the aforementioned splice protectors, the splice protection portion may be structurally configured to receive the strength portion therein.

According to some embodiments of the aforementioned splice protectors, the strength portion may include an elongated flexible portion.

According to some embodiments of the aforementioned splice protectors, the strength portion may include a contoured surface portion facing the splice protection portion, and the contoured surface portion may be structurally configured to limit bending of the splice protection portion to the minimum bend radius.

According to some embodiments of the aforementioned splice protectors, the contoured surface portion may include a sawtooth shape having alternating peaks and valleys along a length of the strength portion.

According to some embodiments of the aforementioned splice protectors, the strength portion may include a helical spring that is configured to encircle the splice protection portion and that is structurally configured to limit bending of the splice protection portion to the minimum bend radius.

According to various embodiments, some of the aforementioned splice protectors may further include an outer protection portion structurally configured to receive the splice protection portion and the strength portion therein.

In accordance with various aspects of the disclosure, a fiber splice protector may include a bend protection portion having a through bore extending along a length thereof and being structurally configured to receive a splice connection of a first fiber with a second fiber. The bend protection portion may be structurally configured to limit bending of the splice connection to a minimize bend radius so as to permit the bend protection portion to be routed along a curved path without degrading optical and mechanical performance of the splice connection.

According to some embodiments of the aforementioned splice protectors, the bend protection portion may include a splice protection portion having a through bore extending along a length thereof and being structurally configured to receive the splice connection therein, and a strength portion configured to extend along at least a portion of the length of the splice protection portion.

According to some embodiments of the aforementioned splice protectors, the strength portion may be structurally configured to receive the splice protection portion therein.

According to some embodiments of the aforementioned splice protectors, the splice protection portion may be structurally configured to receive the strength portion therein.

According to some embodiments of the aforementioned splice protectors, the strength portion comp may include rises an elongated flexible portion.

According to some embodiments of the aforementioned splice protectors, the strength portion may include a contoured surface portion facing the splice protection portion, and the contoured surface portion may be structurally configured to limit bending of the splice protection portion to the minimum bend radius. In some aspects, the contoured surface portion may include a sawtooth shape having alternating peaks and valleys along a length of the strength portion.

According to some embodiments of the aforementioned splice protectors, the strength portion may include a helical spring that is configured to encircle the splice protection portion and that is structurally configured to limit bending of the splice protection portion to the minimum bend radius.

According to various embodiments, some of the aforementioned splice protectors may further include an outer protection portion structurally configured to receive the bend protection portion therein.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments of the disclosure can be practiced.

FIG. 2 is a line representation of portions of an exemplary cable assembly that can be employed in the environment of FIG. 1 in various embodiments of the disclosure.

FIG. 3 is a cross-sectional view of portions of an exemplary fiber splice protector configured in accordance with various embodiments of the disclosure.

FIG. 4 is a cross-sectional view of portions of an exemplary fiber splice protector that can employ a flexible strength member in accordance with various embodiments of the disclosure.

FIG. 5 is a perspective view of portions of an exemplary fiber splice protector arranged in accordance with various embodiments of the disclosure.

FIG. 6 is a cross-sectional view of portions of an exemplary fiber splice protector configured in accordance with various embodiments of the disclosure.

FIG. 7 is a perspective view of portions of an exemplary fiber splice protector capable of utilizing a flexible strength member in accordance with various embodiments of the disclosure.

FIG. 8 is a perspective view of portions of an exemplary fiber splice protector arranged in accordance with various embodiments of the disclosure.

FIG. 9 is a perspective view of portions of an exemplary fiber splice protector arranged in accordance with various embodiments of the disclosure.

FIG. 10 is a perspective view of portions of an exemplary fiber splice protector arranged in accordance with various embodiments of the disclosure.

### DETAILED DESCRIPTION

Embodiments of the disclosure provide a fiber optic cable support member that is structurally configured to provide strength and flexibility to protect a spliced fiber optic cable connection.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The placement of signal carrying cables can pose difficulties during, and after, installation. In cables that carry signals via fiber optic conductors, installation difficulties can be exacerbated. For instance, residential installation sites for fiber optic cables can involve one or more relatively sharp bends, turns, or corners that pose challenges for initially placing the fiber optic cable as well as positioning the cable to provide full signal carrying capabilities. Furthermore, the presence of cable interconnections, such as connectors, adapters, and splices, can be difficult to maneuver and, potentially, focus physical stress on a portion of the cable.

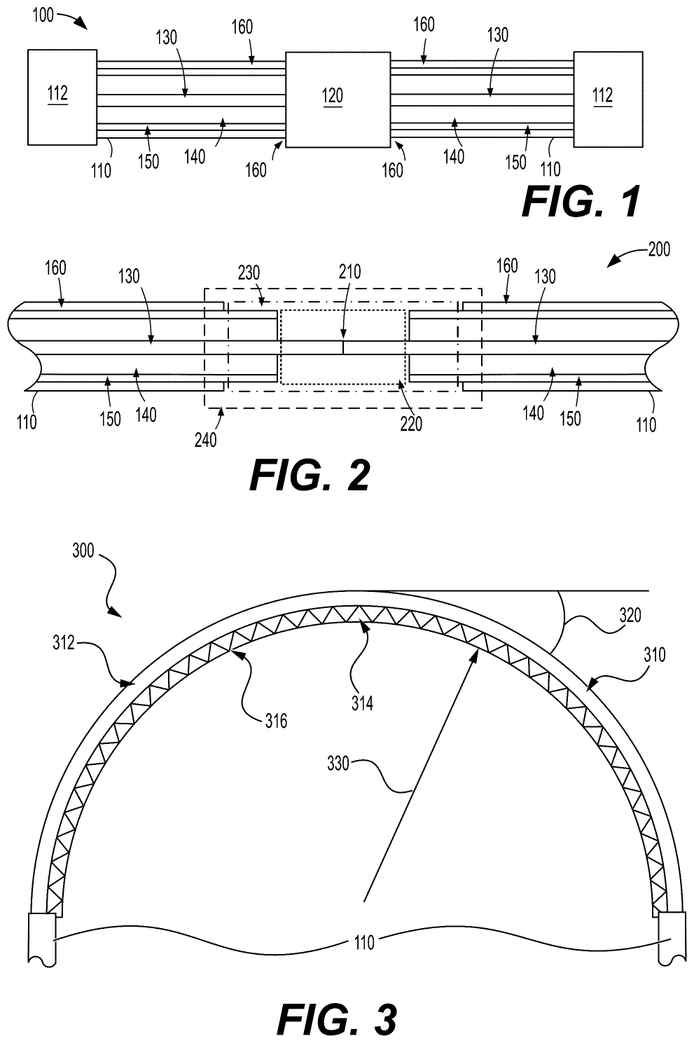

Accordingly, various embodiments are directed to a cable connection member for a fiber optic cable that provides an optimal balance of flexibility and strength to protect a fiber optic connection without jeopardizing cable integrity during, and after, installation. FIG. 1 conveys a line representation of portions of a cable environment 100 in which assorted embodiments of the present disclosure can be practiced. A cable 110 can extend for any length from a source 112 to a terminal 114. Yet, a cable 110 may need one or more interconnects 120 to extend, or terminate, a cable 110, such as with an adapter, connector, interface, or cassette.

An interconnect 120 can connect cables 110 with matching, or dissimilar, configurations. The non-limiting embodiment of FIG. 1 illustrates how a cable 110 can comprise a signal carrying conductor 130 disposed between insulating layers 140 that isolate the conductor 130. A shielding layer 150 can surround the insulating materials of layers 140 to provide protection to the conductor 130, such as magnetic, radio, and other interference protection. An outer jacket 160 can be positioned to surround the collective layers 130/140/150 to provide additional physical and environmental protection to the conductor 130.

When an interconnect 120 is employed to connect two cables 110, as shown, portions of the collective cable 110 can be more susceptible to physical strain than a continuous cable 110 that does not employ an interconnect 120. For instance, the physical engagement of portions of each, separate cable 110 with an interconnect 120 can create regions 170 where physical stress is concentrated, which potentially jeopardizes the integrity of the cable 110 as the cable 110 flexes and is moved over time. With these issues in mind, a goal of embodiments of the present disclosure are generally directed to increasing physical resistance of interconnected cables 110.

FIG. 2 illustrates portions of a cable assembly 200 that can be utilized in the cable environment 100 of FIG. 1 in accordance with various embodiments of the present disclosure. A type of interconnect 120 used to join cables 110 that employ fiber optic conductors 130 is a splice 210. The exemplary splice 210 shown in FIG. 2 conveys how the respective cable conductors 130 are joined at an interface that preserves the optical signal transmission characteristics. It is noted that a splice 210 union may involve arc fusion or mechanical attachment.

Once a stable signal transmission splice 210 is established, the physical region proximal the splice 210 can have less bend resistance compared to non-spliced portions of the cable 110. That is, a splice 210 may fail with less physical force than other, continuous portions of a cable 110 that remain covered by the outer jacket 160. With such physical susceptibility in mind, a splice 210 can be protected by one or more sleeves that provide physical rigidity that prevents bending forces from reaching a disrupting the integrity and performance of the splice 210.

A protective sleeve can be provided in a variety of configurations to protect a splice 210. Some embodiments position a single sleeve 220 that reinforces the integrity of the respective cables 110 by replacing stripped portions of the shielding 150 and insulating 140 materials of the cables 110. The sleeve 220 can be supplemented, or replaced, by a different sleeve 230 that continuously extends to surround the splice 210 along with the non-conductor portions of the respective cables 110. As shown, other sleeve configurations position a sleeve 240 to continuously extend and surround the outer jacket 160 of each cable 110, which consequently covers and protects the splice 210 and any other installed sleeves 220/230.

The ability to customize the number and position of splice 210 protecting sleeves 220/230/240 provides diverse physical characteristics, such as rigidity, tensile strength, torsion strength, and bend resistance, that can cater to different cable 110 installation sites and/or expected environmental conditions. However, providing one or more protecting sleeves 220/230/240 may pose challenges during installation and use. For instance, a rigid sleeve 220/230/240 can be difficult to install in tight spaces and/or sharp bends, such as ducts, channels, corners, and conduits present in many residential sites. Additionally, the construction of a rigid sleeve 220/230/240, such as shrink wrapped or hot melt materials, can rub, erode, and degrade portions of a cable 110 in response to movement of the cable 110 over time, such as during installation, rework, or general use.

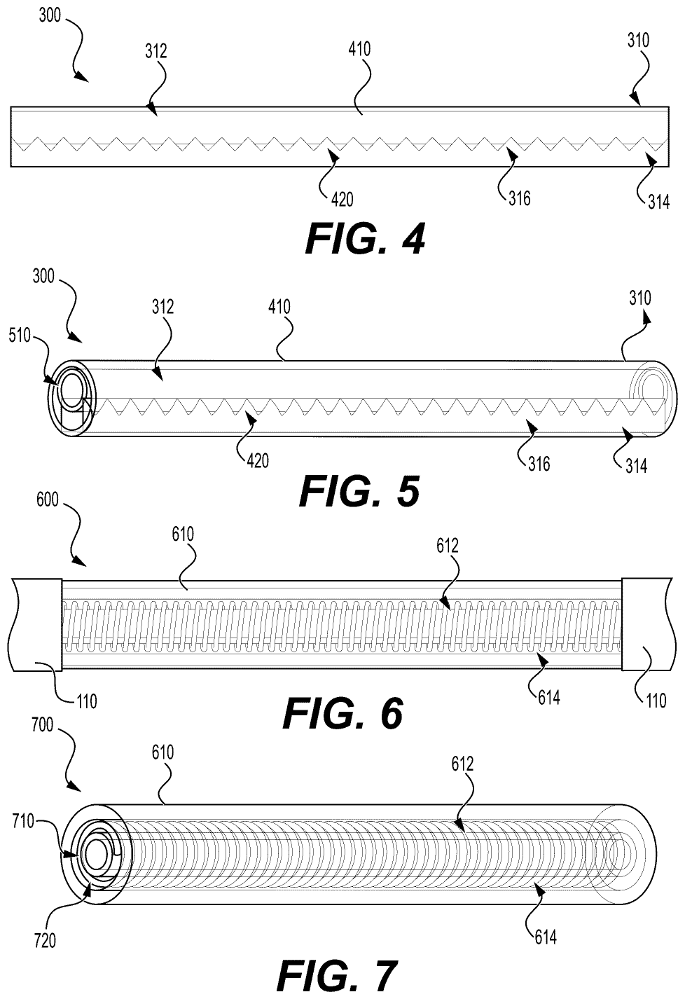

Accordingly, embodiments of a sleeve 220/230/240 can provide strength to protect a splice 210 connection while allowing flexibility to mitigate difficulties and risks associated with installation and use of a spliced cable over time. FIGS. 3 and 4 respectively illustrate cross-sectional and perspective view line representations of a flexible splice protector 300 that can be employed to protect the splice 210 connection of FIG. 2. The splice protector 300 may provide an outer protection portion 310, for example, a continuous tube body, that surrounds selected portions of two joined cables 110, as shown in FIG. 2. The splice protector 300 comprises a splice protection portion or inner protection portion 312 and a strength portion 314 that collectively surround a splice connection, such as splice 210, and portions of joined cables 110.

Although not required or limiting, the splice protection portion 312 may define a continuous aperture positioned adjacent to one or more strength portions 316 of the strength portion 314. The material of the body 310 can provide sufficient flexibility to maintain physical integrity throughout the length of the splice protector 300 in response to a range of bending, torsion, and rotational forces. The strength portion 316 is configured to allow flexibility in the splice protection portion 312 within a predetermined range while increasing the strength of the overall splice protector 300, which can be measured as greater resistance to bending, torsion, or rotational forces than the splice protection portion 312 alone.

The strength portion 316 provides rigidity and strength along with a range of flexibility. In some embodiments, the strength portion 316 restricts movement of the body 310, including the strength portion 314 and splice protection portion 312, beyond a predetermined threshold mechanically set by the configuration of the strength portion 316. As shown in FIG. 3, the predetermined bending threshold provided by the strength portion 316 can correspond with a designated angle 320 or radius 330 that ensures any spliced connections contained in the splice protection portion 312 are physically maintained with peak performance capabilities.

As shown in FIGS. 4 and 5, the body 310 can employ an outer protection portion 410, for example, a unitary outer jacket, that surrounds and protects both the splice protection portion 312 and strength portion 314. The perspective view of FIG. 5 conveys how the unitary outer jacket 410 can surround a splice protection portion 510 and the strength portion 314. In operation, the strength portion 316 has a series of peaks and valleys (i.e., a sawtooth shape) that can be collectively characterized as a restriction feature 420. In the non-limiting embodiment of the restriction feature 420 illustrated in FIGS. 3-5, peaks and valleys provide physical strength while allowing body 310 flexibility until the peaks contact one another, in a first direction, or expand away from one another, in an opposite second direction, to a minimum bend radius of the strength portion 316.

Meanwhile, the restriction feature 420 can have different range of flexibility for lateral body 310 bending. That is, the strength portion 316 can have different ranges of movement along different planes, such as greater vertical range than lateral range, but such configuration is not required. It is contemplated that the outer jacket 410 contains multiple separate strength portions 316 in the strength portion that contribute to providing different, or similar, flexibility in different planes of movement. That is, some embodiments can rotate the strength portion 316, or a separated segment of the portion 316, to provide a similar flexibility range in multiple different planes.

Other embodiments of the strength portion 316 provide varying flexibility ranges along different sections of the splice protector 300. For instance, the size, shape, and spacing of the assorted peaks and valleys of the restriction feature 420 can be tuned to vary along the length of the splice protector 300 to provide different flexibility ranges for different sections of the splice protector 300. In contrast to the uniformly configured aspects of the restriction feature 420 shown in FIGS. 3-5, a restriction feature 420 with a varying configuration may aid installation by allowing greater bending extent away from a splice connection compared to proximal the splice connection.

While the splice protector 300 of FIGS. 3-5 can provide reliable restriction of bending movement in one plane, perhaps multiple planes in some configurations, such arrangement is not required. FIGS. 6 and 7 respectively convey aspects of an exemplary splice protector 600 that can securely house a fiber optic cable 110 interconnection, such as a fiber optic cable splice, while providing infinite planes of restricted movement. The splice protector 600 has a unitary body 610 that includes a continuous length of material, such as a polymer, rubber, or other flexible composition that can protect the cable 110 and strength portion 612 contained therein.

The strength portion 612 can extend along the entire length of the sleeve body 610, as shown, to surround and protect a splice protection portion 710 in which the cable 110 interconnect is physically located. The strength portion 612 is configured as a continuous coil of material, such as spring steel, aluminum, or other flexible metal, that has a number of turns 614 corresponding to a range of movement for the body 610, splice protection portion 710, and constituent cable 110. That is, the strength portion 612 is constructed of a continuous wire of a selected thickness (diameter) that wraps around the splice protection portion 710 a predetermined number of times, which can be characterized as turns 614, to provide physical protection of the splice protection portion 710 while allowing flexibility for the sleeve body 610 in any plane up to a bending threshold corresponding with the configuration of the strength portion 612.

Yet, the splice protector 600 arrangement illustrated in FIGS. 6 and 7 is not required as the strength portion 612 can vary along the length of the splice protector 600, as measured along the longitudinal axis of the body portion 610. For instance, the strength portion 612 may have a varying thickness (diameter) and/or a varying number of turns along the length of the body 610 to tune and adjust the bending limits of the splice protector 600. A non-limiting embodiment of the splice protector 600 positions multiple separate strength portions 612 in the strength portion 720 located between the splice protection portion 710 and outer sleeve jacket that defines the body 610. Such multiple, separate strength portions 612 can provide different bending radius thresholds for different aspects of the body 610 to balance overall splice protector 600 flexibility with protection of the cable interconnect located within the splice protection portion 710.

In the splice protector 600 embodiment shown in FIGS. 6 and 7, the strength portion 612 is configured as a torsion spring that has a uniform construction and arrangement about the splice protection portion 710 throughout the length of the sleeve body 610. As a result, the splice protection portion 710, and cable interconnect located within, can freely move, bend, and flex until the turns 614 contact each other to restrict further movement. Hence, the strength portion 612 is configured to provide sleeve body 610 bending and flexibility up to a range threshold corresponding to the physical configuration of the strength portion 612, or portions that separately occupy the strength portion 720.

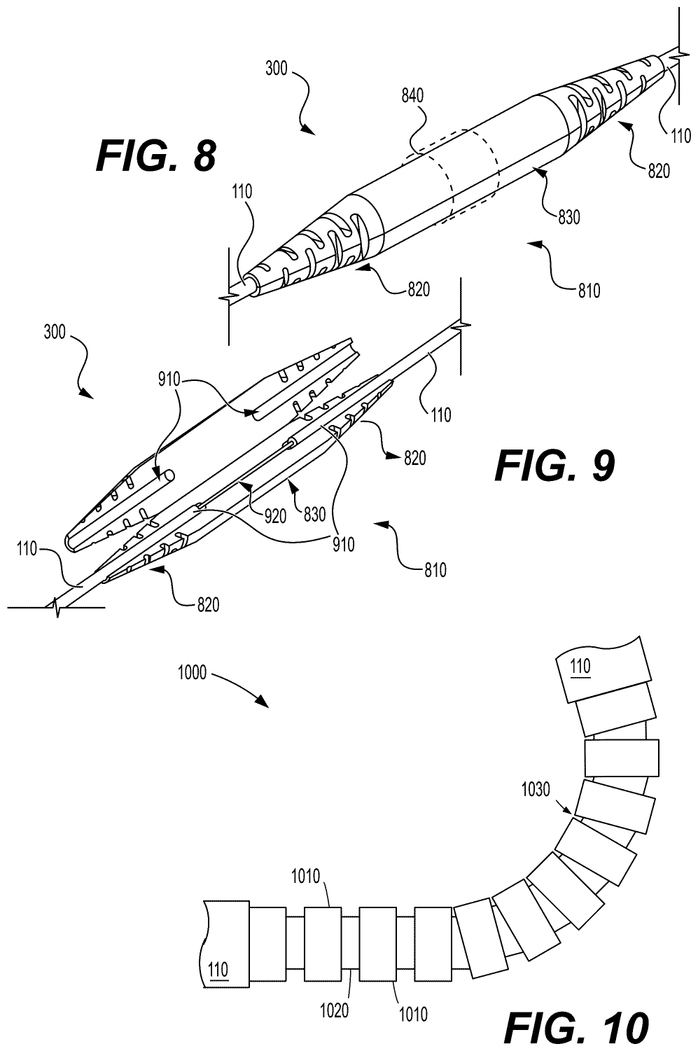

FIGS. 8 and 9 respectively convey aspects of another exemplary fiber splice protector 800 configured in accordance with various embodiments to provide an efficient balance of flexibility and physical protection for a cable interconnect, such as a fiber optic splice. The splice protector 800 has a bend protection portion 810, for example, a semi-rigid body, that includes tapered portions 820 positioned on opposite sides of an interconnection portion 830. Each tapered portion 820 has a number of separate grooves, as shown, to increase the flexibility of the splice protector 800 without jeopardizing the integrity of the splice connection housed in the interconnect portion 830.

The body 810 can have a unitary construction that collectively surrounds and secures at least one interconnect, as shown in FIG. 9. FIG. 9 further illustrates how access to the interconnect can be provided by one or more cuts to the body 810 that allows for efficient visual evaluation and physical manipulation of the cable 110. It is contemplated that the body 810 can be securely closed, as shown in FIG. 8, with one or more retention portions 840 that can be selectively manipulated to allow, or prevent, access to the stripped regions of the cable 110 and the associated interconnection(s) contained within the interconnect portion 830.

A retention portion 840, as illustrated with segmented lines, is not required to be a particular securement mechanism, but in some embodiments surrounds the body 810 and can be selectively set, or removed, cyclically over time. That is, the sleeve 800 may employ one or more mechanisms that ensure the body 810 remains intact to surround and cover the interconnect portion 830 to maintain the body 810 in a closed configuration, as illustrated in FIG. 8 and compared to the open configuration shown in FIG. 9. The retention portion 840 is not limited to a particular mechanism, but some embodiments utilize magnets, hook-and-loop fasteners, adhesive tape, or other bonding agent to close and maintain the sleeve body 810 over time.

The ability to selectively close, or open, the body 810 does not degrade the tuned flexibility of the splice protector 800. That is, the tapered portions 820 can maintain a greater bending range than the interconnect portion 830 while the interconnect portion 830 provides a balance of strength and flexibility that protects the integrity and sustained performance of the interconnect contained therein, such as the cable splice shown in FIG. 9. To facilitate the protection of the cable interconnect, the splice protector 800 is configured with cable grooves 910 that reliably secure complete portions of the cable 110 while an interconnect region 920 is arranged to secure a splice interconnect where aspects of the cable 110 are removed, such as the outer jacket, shielding material, and insulating layer.

The combination of the cable grooves 910 and interconnect region 920 that are differently arranged to physically support aspects of the interconnected cable 110 while providing bending and flexibility within predetermined ranges allows the splice protector 800 to be efficiently deployed in a variety of different installation sites, such as residential and commercial sites, while allowing cyclic access to the cable interconnect.

In comparison to the sleeves 300/600 illustrated in FIGS. 3-7 that employ a strength portion 316/612 to restrict sleeve motion beyond a predetermined threshold, the splice protector 800 of FIGS. 8 and 9 utilize the flexibility characteristics of the body 810 to determine how far the sleeve 800 will bend/flex during installation and operation. In other words, the splice protector 800 of FIGS. 8 and 9 does not utilize a separate strength portion 316/612 and instead employs the bending characteristics of the body portion 810 material, such as a polymer, rubber, or other reliably flexible material, to determine the bending threshold and range of the sleeve 800. Hence, the bending/flexibility range of the splice protector 800 can be tuned via material construction, which contrasts the bending range tuning of splice protectors 300 and 600 that are conducted by altering the strength portions 316/612.

FIG. 10 conveys a line representation of portions of an exemplary splice protector 1000 arranged to provide a predetermined range of movement while protecting one or more cable interconnects. The splice protector 1000 includes a number of segment portions 1010 that are physically connected via joint portions 1020. The respective portions 1010/1020 can be any size, shape, and material, but in some embodiments are rigid components with a substantially circular cross-sectional shape that can safely house at least one interconnection, such as a splice, of a fiber optic cable 110.

Despite rigid, or semi-flexible, construction of the respective portions 1010/1020, the splice protector 1000 has a range of movement allowed by the physical interaction of the segment portions 1010 with the joint portions 1020. As illustrated with part of the splice protector 1000 bending in FIG. 10, the segment portions 1010 have a greater cross-sectional diameter than the joint portions 1020 to allow the segment portions 1010 to tilt and move relative to the joint portions 1020. That is, the splice protector 1000 can move and bend in any plane as segment portions 1010 articulate with respect to adjacent joint portions 1020.

The configuration of the segment portions 1010 corresponds with the bending range, and flexibility limit threshold, for the splice protector 1000. For instance, the size and length of the respective segment portions 1010 compared to the intervening joint portions 1020 provide free bending for the splice protector 1000 until adjacent segment portions 1010 contact one another, as conveyed by region 1030. As increasing numbers of segment portions 1010 contact one another in response to sleeve bending, as shown, further bending and sleeve flexibility is restricted.

The ability to tune the configuration of the respective segment portions 1010 can provide a predetermined bending range for the splice protector 1000 that balances protecting the interconnection contained therein with flexibility to manipulate the sleeve 1000 efficiently. It is contemplated, but not required, that separate segment portions 1010 of a single splice protector 1000 are configured differently to provide a dynamic bending range for different aspects of the splice protector 1000. In other words, separate segment portions 1010 can have different lengths and/or sizes to provide greater, or lesser, bending range for selected portions of the splice protector 1000 corresponding with different amounts of segment portion 1010 movement before contact with an immediately adjacent segment portion 1010. As a result, a splice protector 1000 can be arranged with a uniform bending profile, as shown in FIG. 10 with similarly configured segment portions 1010, or arranged with a dynamic bending profile including differently configured segment portions 1010.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber splice protector configured to permit routing of a fiber splice connection along a curved path without degrading optical and mechanical performance of the fiber splice connection comprising:
an inner protection portion having a through bore extending along a length thereof and being structurally configured to receive a fiber splice portion therein;
a strength portion configured to extend along at least a portion of the length of the inner protection portion;
an outer protection portion having a through bore extending along a length thereof and being structurally configured to receive the inner protection portion and the strength portion therein;
wherein the fiber splice portion comprises a splice connection of a first fiber with a second fiber; and
wherein the strength portion is structurally configured to limit bending of the fiber splice portion to a minimize bend radius so as to permit the outer protection portion to be routed along a curved path without degrading optical and mechanical performance of the fiber splice portion.

2. The fiber splice protector of claim 1, wherein the strength portion comprises an elongated flexible portion.

3. The fiber splice protector of claim 1, wherein the strength portion includes a contoured surface portion facing the inner protection portion; and
wherein the contoured surface portion is structurally configured to limit bending of the fiber splice portion to the minimum bend radius.

4. The fiber splice protector of claim 1, wherein the strength portion comprises a helical spring that is configured to encircle the inner protection portion and that is structurally configured to limit bending of the fiber splice portion to the minimum bend radius.

5. A fiber splice protector configured to permit routing of a fiber splice connection along a curved path without degrading optical and mechanical performance of the fiber splice connection comprising:
a splice protection portion having a through bore extending along a length thereof and being structurally configured to receive a splice connection of a first fiber with a second fiber therein;
a strength portion configured to extend along at least a portion of the length of the splice protection portion; and
wherein the strength portion is structurally configured to limit bending of the splice connection to a minimize bend radius so as to permit the strength portion to be routed along a curved path without degrading optical and mechanical performance of the splice connection.

6. The fiber splice connector of claim 5, wherein the strength portion is structurally configured to receive the splice protection portion therein.

7. The fiber splice connector of claim 5, wherein the splice protection portion is structurally configured to receive the strength portion therein.

8. The fiber splice protector of claim 5, wherein the strength portion comprises an elongated flexible portion.

9. The fiber splice protector of claim 5, wherein the strength portion includes a contoured surface portion facing the splice protection portion; and
wherein the contoured surface portion is structurally configured to limit bending of the splice protection portion to the minimum bend radius.

10. The fiber splice protector of claim 9, wherein the contoured surface portion comprises a sawtooth shape having alternating peaks and valleys along a length of the strength portion.

11. The fiber splice protector of claim 5, wherein the strength portion comprises a helical spring that is configured to encircle the splice protection portion and that is structurally configured to limit bending of the splice protection portion to the minimum bend radius.

12. The fiber splice connector of claim 5, further comprising an outer protection portion structurally configured to receive the splice protection portion and the strength portion therein.

13. A fiber splice protector configured to permit routing of a fiber splice connection along a curved path without degrading optical and mechanical performance of the fiber splice connection comprising:
a bend protection portion having a through bore extending along a length thereof and being structurally configured to receive a splice connection of a first fiber with a second fiber; and
wherein the bend protection portion is structurally configured to limit bending of the splice connection to a minimize bend radius so as to permit the bend protection portion to be routed along a curved path without degrading optical and mechanical performance of the splice connection.

14. The fiber splice connector of claim 13, wherein bend protection portion comprises:
a splice protection portion having a through bore extending along a length thereof and being structurally configured to receive the splice connection therein; and
a strength portion configured to extend along at least a portion of the length of the splice protection portion.

15. The fiber splice connector of claim 14, wherein the strength portion is structurally configured to receive the splice protection portion therein.

16. The fiber splice connector of claim 14, wherein the splice protection portion is structurally configured to receive the strength portion therein.

17. The fiber splice protector of claim 14, wherein the strength portion comprises an elongated flexible portion.

18. The fiber splice protector of claim 14, wherein the strength portion includes a contoured surface portion facing the splice protection portion; and
wherein the contoured surface portion is structurally configured to limit bending of the splice protection portion to the minimum bend radius.

19. The fiber splice protector of claim 18, wherein the contoured surface portion comprises a sawtooth shape having alternating peaks and valleys along a length of the strength portion.

20. The fiber splice protector of claim 14, wherein the strength portion comprises a helical spring that is configured to encircle the splice protection portion and that is structurally configured to limit bending of the splice protection portion to the minimum bend radius.

21. The fiber splice connector of claim 13, further comprising an outer protection portion structurally configured to receive the bend protection portion therein.

22. The fiber splice protector of claim 3, wherein the contoured surface portion comprises a sawtooth shape having alternating peaks and valleys along a length of the strength portion.
